(19) United States
(12) Patent Application Publication
(10) Pub. No.: US 2024/0067579 A1
(43) Pub. Date: Feb. 29, 2024

(54) SURFACE TREATMENT AGENT, HYDROPHILIZED INORGANIC SUBSTRATE, AND METHOD FOR PRODUCING SAME

(71) Applicants: LIXIL Corporation, Tokyo (JP); NIPPON PAINT AUTOMOTIVE COATINGS CO., LTD., Osaka (JP)

(72) Inventors: Yoshihito OKUMURA, Shinagawa-ku, Tokyo (JP); Yusuke NAKASHIMA, Shinagawa-ku, Tokyo (JP); Kazuki YOSHIOKA, Shinagawa-ku, Tokyo (JP); Takahito NAKASE, Shinagawa-ku, Tokyo (JP); Yusuke SATO, Shinagawa-ku, Tokyo (JP); Yugo TAKEMOTO, Hirakata-shi, Osaka (JP); Kiyoe MAEJIMA, Hirakata-shi, Osaka (JP)

(73) Assignees: LIXIL Corporation, Tokyo (JP); NIPPON PAINT AUTOMOTIVE COATINGS CO., LTD., Osaka (JP)

(21) Appl. No.: 18/267,916

(22) PCT Filed: Dec. 13, 2021
(86) PCT No.: PCT/JP2021/045851

§ 371 Date: Jun. 16, 2023

(30) Foreign Application Priority Data
Dec. 21, 2020 (JP) 2020-211303

(51) Int. Cl. C04B 41/45; C04B 41/49

(52) U.S. Cl. CPC C04B 41/4552; C04B 41/4556; C04B 41/4558; C04B 41/4922; C04B 2235/963

(57) ABSTRACT

Provided is a surface treatment agent capable of imparting superior antifouling property as well as good and durable hydrophilicity to an inorganic substrate. The surface treatment agent is one comprising a pretreatment agent and a hydrophilizing treatment agent and being to be sequentially applied to an inorganic substrate, wherein the pretreatment agent comprises a silane compound having a reactive silyl group and an organic functional group and a polyfunctional monomer, and the polyfunctional monomer has one or more first reactive groups that react with the organic functional group and one or more second reactive groups that react with the hydrophilizing treatment agent.

### TECHNICAL FIELD

The present invention relates to a surface treatment agent, a hydrophilized inorganic substrate, and a method for producing the hydrophilized inorganic substrate.

### BACKGROUND ART

Conventionally, with respect to crockery to be installed at a water-using site in a building, such as a toilet bowl and a washstand, various types of surface treatment are applied to make washing of a surface soil easy.

For example, Patent Literature 1 and 2 teach that a surface layer containing an inorganic compound is treated with a silane coupling agent and then a hydrophilic compound is applied.

### CITATIONS LIST

### Patent Literatures

Patent Literature 1: JP-A-2016-20461
Patent Literature 2: JP-A-2016-20462

### SUMMARY OF INVENTION

### Technical Problems

Due to the recent increasing cleanliness, there is a demand for further improvement of antifouling property for crockery.

The present invention solves the above problems, and an object thereof is to provide a surface treatment agent capable of imparting superior antifouling property as well as good and durable hydrophilicity to an inorganic substrate such as crockery.

### Solutions to Problems

In order to solve the above-described problems, the present invention provides the following embodiments.

[1]

A surface treatment agent to be provided to an inorganic substrate,
the surface treatment agent comprising a hydrophilizing treatment agent and a pretreatment agent, wherein
the pretreatment agent comprises:
a silane compound having a reactive silyl group and an organic functional group, and
a polyfunctional monomer, wherein
the polyfunctional monomer has:
one or more first reactive groups that react with the organic functional group, and
one or more second reactive groups that react with the hydrophilizing treatment agent.
   [2]

The surface treatment agent according to [1], wherein a blending amount of the polyfunctional monomer is 1% by mass or more and 99% by mass or less of a solid content of the pretreatment agent.

[3]

The surface treatment agent according to [1] or [2], wherein the first reactive group is at least one selected from the group consisting of an acrylamide group, an acryloyl group, a methacryloyl group, an allyl group, a vinyl group, a styryl group, and a mercapto group.

[4]

The surface treatment agent according to any one of [1] to [3], wherein the second reactive group is at least one selected from the group consisting of an acrylamide group, an acryloyl group, a methacryloyl group, an allyl group, a vinyl group, a styryl group, and a mercapto group.

[5]

The surface treatment agent according to any one of [1] to [4], wherein the hydrophilizing treatment agent comprises a hydrophilic compound, and

the hydrophilic compound has at least one of a sulfonic acid group and an alkali metal salt of a sulfonic acid group.

[6]

The surface treatment agent according to any one of [1] to [4], wherein the hydrophilizing treatment agent comprises a hydrophilic compound, and

the hydrophilic compound has a quaternary ammonium group.

[7]

A hydrophilized inorganic substrate to which a pretreatment agent and a hydrophilizing treatment agent have been sequentially applied, wherein
the pretreatment agent comprises a silane compound having a reactive silyl group and an organic functional group, and a polyfunctional monomer,
the polyfunctional monomer has one or more first reactive groups that react with the organic functional group and one or more second reactive groups that react with the hydrophilizing treatment agent, and
the hydrophilized inorganic substrate comprises:
an inorganic substrate,
the silane compound fixed to the inorganic substrate via the reactive silyl group,
the polyfunctional monomer fixed to the silane compound through a reaction between the organic functional group and the first reactive group, and
the hydrophilizing treatment agent fixed to the polyfunctional monomer through a reaction between the second reactive group and the hydrophilizing treatment agent.
   [8]

A method for producing a hydrophilized inorganic substrate, the method comprising:
applying a pretreatment agent to a surface of an inorganic substrate;
applying a hydrophilizing treatment agent to a surface of the inorganic substrate to which the pretreatment agent has been applied; and
fixing the hydrophilizing treatment agent to the pretreatment agent,
wherein
the pretreatment agent comprises a silane compound having a reactive silyl group and an organic functional group, and a polyfunctional monomer,
the polyfunctional monomer has one or more first reactive groups that react with the organic functional group and one or more second reactive groups that react with the hydrophilizing treatment agent, and
in the fixing, the first reactive group and the organic functional group react with each other, and the hydrophilizing treatment agent and the second reactive group react with each other.

### Advantageous Effects of Invention

According to the present invention, a surface treatment agent capable of imparting superior antifouling property as well as good and durable hydrophilicity to an inorganic substrate.

### DESCRIPTION OF EMBODIMENTS

### [Surface Treatment Agent]

The surface treatment agent according to the present embodiment comprises a pretreatment agent and a hydrophilizing treatment agent. By treating an inorganic substrate with both the pretreatment agent and the hydrophilizing treatment agent, the hydrophilicity of the inorganic substrate and the durability of the hydrophilicity are improved. For example, even when the resulting inorganic substrate is washed with various commercially available detergents, the hydrophilicity of the inorganic substrate is easily maintained.

In addition, the surface treatment agent according to the present embodiment imparts superior antifouling property to inorganic substrates. In particular, the surface treatment agent according to the present embodiment makes inorganic substrates likely to allow mineral components (fur) that may be contained in tap water, such as calcium, to be removed therefrom. When the mineral component is deposited on a surface of an inorganic substrate, irregularities are formed on the surface, so that soil is more easily attached and less easily removed.

The pretreatment agent and the hydrophilizing treatment agent have not been mixed, and are sequentially applied to an inorganic substrate. Thus, the effects of the respective treatment agents are exerted, so that hydrophilicity and the durability thereof, and also antifouling property are improved.

### A. Pretreatment Agent

The pretreatment agent is used to strongly fix the hydrophilizing treatment agent to the inorganic substrate. The pretreatment agent comprises a silane compound and a polyfunctional monomer. The polyfunctional monomer has two or more reactive groups. Specifically, the polyfunctional monomer has one or more first reactive groups that react with the organic functional group of the silane compound, and one or more second reactive groups that react with the hydrophilizing treatment agent.

The polyfunctional monomer is fixed to a surface of the inorganic substrate via the silane compound. The hydrophilizing treatment agent (specifically, the hydrophilic compound described later) is fixed to the second reactive group of the polyfunctional monomer. That is, many crosslinking points between the inorganic substrate and the hydrophilic compound are formed by the polyfunctional monomer and, as a result, more hydrophilic compounds are made to be easily fixed to the surface of the inorganic substrate. This is considered to make it difficult for the mineral component to adhere to the surface of the inorganic substrate, thereby improving the antifouling property.

In the following, the respective components are described in detail.

### (Polyfunctional Monomer)

The polyfunctional monomer has one or more first reactive groups and one or more second reactive groups. The first reactive group can react with an organic functional group of the silane compound. The second reactive group can react with the hydrophilizing treatment agent. The first reactive group and the second reactive group may be of either the same kind or different kinds.

That the polyfunctional monomer has one or more first reactive groups means that one or more reactive groups of the polyfunctional monomer can be chemically bonded to the silane compound. The fact that the polyfunctional monomer has one or more second reactive groups means that one or more reactive groups of the polyfunctional monomer can be chemically bonded to the hydrophilizing treatment agent.

Regarding the first reactive group, the polyfunctional monomer is just required to have one or more groups, and may have two or more groups. In particular, the polyfunctional monomer preferably has one first reactive group. Thus, one or more polyfunctional monomers can be fixed on one silane compound. As a result, more hydrophilizing treatment agent can be fixed to the surface of the inorganic substrate, and the antifouling property is more easily improved.

The first reactive group is not particularly limited as long as it reacts with the organic functional group of the silane compound. The reaction between the first reactive group and the organic functional group may be either a radical reaction or a condensation reaction.

Examples of the first reactive group that undergoes a radical reaction include at least one selected from the group consisting of an acrylamide group, an acryloyl group, a methacryloyl group, an allyl group, a vinyl group, a styryl group, and a mercapto group. Examples of the first reactive group that undergoes a condensation reaction include a carboxy group, a hydroxy group, an amino group, an epoxy group, a ureido group, an isocyanate group, and an isocyanurate group. A plurality of first reactive groups may be of either the same kind or different kinds. In particular, radical reactive groups are preferable, and from the viewpoint of high reactivity, an acryloyl group and a methacryloyl group (hereinafter, these group are collectively referred to as a (meth)acryloyl group) are preferable, and a methacryloyl group is more preferable.

Regarding the second reactive group, the polyfunctional monomer is just required to have one or more groups. In particular, the polyfunctional monomer preferably have two or more second reactive groups, and more preferably five or more second reactive groups. Thus, more hydrophilizing treatment agent can be fixed to the surface of the inorganic substrate, and the antifouling property is more easily improved.

The second reactive group is not particularly limited as long as it reacts with the hydrophilizing treatment agent. The reaction between the second reactive group and the hydrophilizing treatment agent may be either a radical reaction or a condensation reaction.

Examples of the second reactive group that undergoes the radical reaction include the same groups as those recited as examples of this type of the first reactive group. Examples of the second reactive group that undergoes the condensation reaction include the same groups as those recited as examples of this type of the first reactive group. A plurality of second reactive groups may be of either the same kind or different kinds. In particular, radical reactive groups are preferable, and from the viewpoint of high reactivity, a (meth)acryloyl group is preferable, and a methacryloyl group is more preferable.

Examples of the polyfunctional monomer having (meth)acryloyl groups as the first reactive group and the second reactive group include bifunctional (meth)acrylate monomers such as tripropylene glycol diacrylate and isocyanuric acid EO-modified diacrylate; trifunctional (meth)acrylate monomers such as glycerin tri(meth)acrylate, trimethylolpropane tri(meth)acrylate, ethoxylated (3) trimethylolpropane triacrylate, ethoxylated (6) trimethylolpropane triacrylate, ethoxylated (9) trimethylolpropane triacrylate, propoxylated (3) trimethylolpropane triacrylate, propoxylated (6) trimethylolpropane triacrylate, propoxylated (9) trimethylolpropane triacrylate, pentaerythritol tri(meth)acrylate, dipentaerythritol tri(meth)acrylate, ethoxylated (4) pentaerythritol tri(meth)acrylate, ethoxylated (8) pentaerythritol tri(meth)acrylate, tris(2-hydroxyethyl)isocyanurate tri(meth)acrylate, ε-caprolactone-modified (1) tris(2-hydroxyethyl)isocyanurate tri(meth)acrylate, and ε-caprolactone-modified (3) tris(2-hydroxyethyl)isocyanurate tri(meth)acrylate; tetrafunctional (meth)acrylate monomers such as pentaerythritol tetra(meth)acrylate, dipentaerythritol tetra(meth)acrylate, tripentaerythritol tetra(meth)acrylate, ditrimethylolpropane tetra(meth)acrylate, ethoxylated (4) pentaerythritol tetra(meth)acrylate, and ethoxylated (8) pentaerythritol tetra(meth)acrylate; pentafunctional (meth)acrylate monomers such as dipentaerythritol penta(meth)acrylate and tripentaerythritol penta(meth)acrylate; hexafunctional (meth)acrylate monomers such as dipentaerythritol hexa(meth)acrylate, ε-caprolactone-modified dipentaerythritol hexa(meth)acrylate, and tripentaerythritol hexa(meth)acrylate; and hepta or more functional (meth)acrylate monomers such as tripentaerythritol hepta(meth)acrylate and tripentaerythritol octa(meth)acrylate.

The blending amount of the polyfunctional monomer is preferably 1% by mass or more and 99% by mass or less of a solid content of the pretreatment agent. The blending amount of the polyfunctional monomer is more preferably 15% by mass or more, and still more preferably 40% by mass or more of the solid content of the pretreatment agent. The blending amount of the polyfunctional monomer is more preferably 95% by mass or less, and still more preferably 85% by mass or less of the solid content of the pretreatment agent. The solid content of the pretreatment agent means the amount of all components excluding volatile components (typically, a solvent to be described later).

### (Silane Compound)

The silane compound has both a reactive silyl group and an organic functional group. Such a silane compound is known as a silane coupling agent. The reactive silyl group generates a silanol group through hydrolysis. The silanol group is adsorbed onto and bonded in a hydrogen bonding manner to a surface of an inorganic substrate. Furthermore, when the silanol group undergoes dehydration condensation with a hydroxy group or a silanol group present on the surface of the inorganic substrate, a strong chemical bond is generated. By these actions, the silane compound is fixed to the surface of the inorganic substrate. On the other hand, the organic functional group reacts with the polyfunctional monomer to bond the polyfunctional monomer and the silane compound each other.

The reactive silyl group is not particularly limited as long as it generates a silanol group through hydrolysis. Examples of the reactive silyl group include trialkoxysilyl groups (the number of the carbon atoms contained in each of the alkoxy groups is preferably 1 to 7) and dialkoxyalkyl groups (the number of the carbon atoms contained in each of the alkoxy groups is preferably 1 to 7, and the number of the carbon atoms contained in the alkyl group is preferably 1 to 7), and more specific examples include a trimethoxysilyl group, a triethoxysilyl group, a tripropoxysilyl group, a tris(2-methoxyethoxy)silyl group, dimethoxyalkylsilyl groups, diethoxyalkylsilyl groups, dipropoxyalkylsilyl groups, and bis(2-methoxyethoxy)alkylsilyl groups (the alkyl groups each may be a linear or branched alkyl group having 1 to 7 carbon atoms). A plurality of reactive silyl groups may be of either the same kind or different kinds.

The organic functional group is not particularly limited as long as it reacts with the first reactive group of the polyfunctional monomer. As described above, the reaction between the organic functional group and the first reactive group may be either a radical reaction or a condensation reaction.

Examples of the organic functional group that undergoes the radical reaction include the same groups as those recited as examples of this type of the first reactive group. Examples of the organic functional group that undergoes the condensation reaction include the same groups as those recited as examples of this type of the first reactive group. A plurality of organic functional groups may be of either the same kind or different kinds.

Examples of the silane compound include vinyltriethoxysilane, vinyltrimethoxysilane, vinyltris(2-methoxyethoxy)silane, vinylmethyldimethoxysilane, p-styryltrimethoxysilane, p-styryltriethoxysilane, 3-methacryloxypropyltriethoxysilane, 3-methacryloxypropyltrimethoxysilane, 3-methacryloxypropylmethyldimethoxysilane, 3-methacryloxypropylmethyldiethoxysilane, 3-acryloxypropyltrimethoxysilane, 3-acryloxypropyldimethoxysilane, 2-(3,4-epoxycyclohexyl)ethyltrimethoxysilane, 3-glycidoxypropyltrimethoxysilane, 3-glycidoxypropyltriethoxysilane, 3-glycidoxypropylmethyldimethoxysilane, 3-glycidoxypropylmethyldiethoxysilane, 3-mercaptopropylmethyldimethoxysilane, 3-mercaptopropyltrimethoxysilane, 3-mercaptopropyltriethoxysilane, 3-octanoylthio-1-propyltriethoxysilane, 3-aminopropyltriethoxysilane, 3-aminopropyltrimethoxysilane, N-(2-aminoethyl)-3-aminopropyltrimethoxysilane, N-(2-aminoethyl)-3-aminopropylmethyldimethoxysilane, 3-(N-phenyl)aminopropyltrimethoxysilane, 3-triethoxysilyl-N-(1,3-dimethyl-butylidene)propylamine, N-(vinylbenzyl)-2-aminoethyl-3-aminopropyltrimethoxysilane, 3-ureidopropyltriethoxysilane, 3-isocyanatopropyltriethoxysilane, 3-isocyanatopropyltrimethoxysilane, and tris-(trimethoxysilylpropyl) isocyanurate. Such silane compounds are used singly or two or more of them are used in combination.

The blending amount of the silane compound is preferably 1% by mass or more and 99% by mass or less of the solid content of the pretreatment agent. Thus, sufficient hydrophilicity can be imparted to an inorganic substrate, and gelation due to excessive progress of the condensation reaction between the reactive silyl groups is easily prevented. The blending amount of the silane compound is more preferably 15% by mass or more, and still more preferably 20% by mass or more of the solid content of the pretreatment agent. The blending amount of the silane compound is more preferably 85% by mass or less, and still more preferably 60% by mass or less of the solid content of the pretreatment agent.

### (Radical Polymerization Initiator)

When the silane compound and the polyfunctional monomer together undergo a radical reaction, the pretreatment agent may further contain a radical polymerization initiator. However, from the viewpoint that polymerization between polyfunctional monomers can be easily controlled, it is desirable that the pretreatment agent contains substantially no radical polymerization initiator (the blending amount of the radical polymerization initiator is equal to or less than the detection limit).

### (Catalyst)

The pretreatment agent may contain a catalyst that promotes hydrolysis of the reactive silyl group. Examples of the catalyst include acidic catalysts such as hydrochloric acid, sulfuric acid, nitric acid, phosphoric acid, and carboxylic acids (e.g., formic acid, acetic acid, and propionic acid) and basic catalysts such as ammonia, morpholine, N-methylmorpholine, N-ethylmorpholine, piperazine, hydroxyethylpiperazine, 2-methylpiperazine, trans-2,5-dimethylpiperazine, cis-2,6-dimethylpiperazine, triethylamine, N,N-dimethylethanolamine, N,N-diethylethanolamine, N-(β-aminoethypethanolamine, N-methyldiethanolamine, N-n-butylethanolamine, N-n-butyldiethanolamine, N-t-butylethanolamine, N-t-butyldiethanolamine, N-(β-aminoethyl)isopropanolamine, N,N-diethylisopropanolamine, 2-amino-2-methyl-1-propanol, sodium hydroxide, and potassium hydroxide. The catalyst is added to the pretreatment agent in the form of, for example, an aqueous solution.

### (Solvent)

The pretreatment agent may contain a solvent. The solvent may be either an organic solvent or water. Examples of the organic solvent include alcohols such as methanol, ethanol, isopropyl alcohol, n-propyl alcohol, and 1-methoxy-2-propanol; ketones such as methyl ethyl ketone and methyl isobutyl ketone; and esters such as ethyl acetate.

### B. Hydrophilizing Treatment Agent

The hydrophilizing treatment agent imparts hydrophilicity to an inorganic substrate. The hydrophilizing treatment agent contains a hydrophilic compound. The hydrophilic compound has a third reactive group that reacts with the second reactive group of the polyfunctional monomer, and a hydrophilic group. That the second reactive group of the polyfunctional monomer can react with the hydrophilizing treatment agent means that the second reactive group can react with the third reactive group of the hydrophilic compound.

### (Hydrophilic Compound)

The hydrophilic compound has a third reactive group that reacts with the second reactive group of the polyfunctional monomer, and a hydrophilic group.

Regarding the third reactive group, the hydrophilic compound is just required to have one or more groups, and may have two or more groups. In particular, the hydrophilic compound preferably has one third reactive group. Thus, one or more hydrophilic compounds can be fixed on one polyfunctional monomer. Therefore, more hydrophilic groups are easily fixed to a surface of an inorganic substrate, and the hydrophilicity and the antifouling property are more easily improved. The hydrophilic compound can also be fixed to the silane compound.

The third reactive group is not particularly limited as long as it reacts with the second reactive group of the polyfunctional monomer. As described above, the reaction between the third reactive group and the second reactive group may be either a radical reaction or a condensation reaction.

Examples of the third reactive group that undergoes the radical reaction include the same groups as those recited as examples of this type of the first reactive group. Examples of the third reactive group that undergoes the condensation reaction include the same groups as those recited as examples of this type of the first reactive group. A plurality of third reactive groups may be of either the same kind or different kinds.

Regarding the hydrophilic group, the hydrophilic compound is just required to have one or more groups, and may have two or more groups. The hydrophilic group is desirably located at an end of the main chain of the hydrophilic compound. Thus, it becomes easy to dispose the hydrophilic group toward the outside of the inorganic substrate, and the hydrophilicity is more easily improved.

The hydrophilic group is not particularly limited. The hydrophilic group may be any of cationic, anionic, amphoteric, and nonionic.

Anionic hydrophilic groups dissociate into anions in water. Examples of the anionic hydrophilic group include a carboxylic acid group, a sulfonic acid group, a phosphoric acid group, and salts thereof. Among them, a sulfonic acid group and a salt of a sulfonic acid group (hereinafter, these may be referred to as “sulfonic acid groups”) are preferable as the hydrophilic group. In particular, an alkali metal salt of a sulfonic acid group is preferable.

Examples of a hydrophilic compound having a sulfonic acid groups include vinylsulfonic acid, N-t-butylacrylamide sulfonic acid, sodium vinylsulfonate, lithium N-t-butylacrylamide sulfonate, sodium N-t-butylacrylamide sulfonate, potassium N-t-butylacrylamide sulfonate, 2-sodium sulfoethyl methacrylate, sodium allylsulfonate, sodium p-styrenesulfonate, and sodium sulfonate-containing urethane acrylate. These are used singly or two or more of them are used in combination. A hydroxide of an alkali metal such as sodium hydroxide or potassium hydroxide may be added together with the hydrophilic compound having a sulfonic acid group. Thus, the sulfonic acid is neutralized to form a sulfonate salt.

Cationic hydrophilic groups dissociate into cations in water. Examples of the cationic hydrophilic group include a quaternary ammonium group. Examples of the hydrophilic compound having a quaternary ammonium group include (3-acrylamidopropyl)trimethylammonium chloride, (3-acrylamidopropyl)trimethylammonium bromide, [3-(methacryloylamino)propyl]trimethylammonium chloride, 2-(acryloyloxy)-N,N,N-trimethylethanaminium chloride, and 2-(methacryloyloxy)ethyltrimethylammonium chloride. These are used singly or two or more of them are used in combination.

Amphoteric hydrophilic groups dissociate into anions and cations in water. Examples of the amphoteric hydrophilic compound include alkyl betaine-based compounds such as lauryldimethylaminoacetic acid betaine; fatty acid amidopropyl betaine-based compounds such as cocamidopropyl betaine; amino acid-based compounds such as sodium lauroyl glutamate; and amine oxide-based compounds such as lauryldimethylamine N-oxide.

Nonionic hydrophilic groups do not dissociate into ions in water. Examples of the nonionic hydrophilic compound include alkyl glycosides, fatty acid esters, alkyl polyethylene glycols, and polyvinyl alcohol.

The hydrophilizing treatment agent preferably comprises a hydrophilic compound having a cationic or nonionic hydrophilic group together with a hydrophilic compound having an anionic hydrophilic group. In particular, the hydrophilizing treatment agent preferably contains a hydrophilic compound having a cationic hydrophilic group together with a hydrophilic compound having an anionic hydrophilic group.

The number average molecular weight of the hydrophilic compound is preferably 70 or more and 500 or less. When the number average molecular weight is within the above range, the hydrophilicity is more easily improved. The blending amount of the hydrophilic compound is not particularly limited.

### (Radical Polymerization Initiator)

When the silane compound and the hydrophilic compound together undergo a radical reaction, the hydrophilizing treatment agent may further contain a radical polymerization initiator. The radical polymerization initiator is preferably soluble in water. Radical polymerization initiators are classified into photo-radical polymerization initiators that are decomposed by light and thermal radical polymerization initiators that are decomposed by heat.

The radical polymerization initiator is not particularly limited, and conventionally known radical polymerization initiators can be used. The blending amount of the radical polymerization initiator is preferably 1 part by mass or more and 75 parts by mass or less, and more preferably 5 parts by mass or more and 60 parts by mass or less based on 100 parts by mass of a solid content of the hydrophilic compound.

### (Solvent)

The hydrophilizing treatment agent may contain a solvent. Examples of the solvent include the same solvents as those contained in the pretreatment agent. The solid component concentration of the hydrophilizing treatment agent can be adjusted to 0.1% by mass or more and 60% by mass or less with a solvent.

### (Compatibilizer)

The hydrophilizing treatment agent may contain a compatibilizer. The compatibilizer can prevent crystallization of the hydrophilic compound and can make the hydrophilic compound uniformly dissolve in the hydrophilizing treatment agent.

The compatibilizer is not particularly limited, and conventionally known compatibilizers can be used. The addition amount of the compatibilizer is preferably 10 parts by mass or more and 100 parts by mass or less based on 100 parts by mass of the solid content of the hydrophilic compound.

### (Others)

The hydrophilizing treatment agent may comprise various additives, as necessary. Examples of the additive include a surface conditioning agent, a leveling agent, a plasticizer, an antifoaming agent, an ultraviolet absorber, an antioxidant, and a viscosity modifier. Such additives are used singly or two or more of them are used in combination.

### [Hydrophilized Inorganic Substrate]

The hydrophilized inorganic substrate according to the present embodiment is obtained by sequentially applying the pretreatment agent and the hydrophilizing treatment agent to an inorganic substrate. The pretreatment agent comprises a silane compound having a reactive silyl group and an organic functional group, and a polyfunctional monomer. The polyfunctional monomer has one or more first reactive groups that react with the organic functional group and one or more second reactive groups that react with the hydrophilizing treatment agent. That is, the hydrophilized inorganic substrate comprises an inorganic substrate, a silane compound, a polyfunctional monomer, and a hydrophilizing treatment agent. The silane compound is fixed to the inorganic substrate via the reactive silyl group. The polyfunctional monomer is fixed to the silane compound through a reaction between the organic functional group of the silane compound and the first reactive group. The hydrophilizing treatment agent is fixed to the polyfunctional monomer through a reaction with the second reactive group.

### [Method for Producing Hydrophilized Inorganic Substrate]

The hydrophilized inorganic substrate according to the present embodiment is produced by a method comprising applying the pretreatment agent to a surface of an inorganic substrate, applying the hydrophilizing treatment agent to the surface of the inorganic substrate to which the pretreatment agent has been applied, and fixing the hydrophilizing treatment agent to the pretreatment agent. In the fixing, the first reactive group of the polyfunctional monomer reacts with the organic functional group of the silane compound, and the hydrophilic compound reacts with the second reactive group of the polyfunctional monomer.

### (1) Applying Pretreatment Agent

The pretreatment agent is applied to a surface of an inorganic substrate. The pretreatment agent comprises a silane compound and a polyfunctional monomer. The pretreatment agent may further comprise a solvent.

In the pretreatment agent, at least part of the reactive silyl groups of the silane compound has been hydrolyzed and generated a silanol group. When the pretreatment agent is applied to a surface of an inorganic substrate, the silanol group is adsorbed onto and bonded in a hydrogen bonding manner to the surface of the inorganic substrate. Furthermore, the silanol group undergoes dehydration condensation with a hydroxy group or a silanol group present on the surface of the inorganic substrate and can be chemically bonded. As a result, the silane compound is fixed to the surface of the inorganic substrate. On the other hand, at least part of the polyfunctional monomers are present as they are in the vicinity of the surface of the inorganic substrate. The application amount of the pretreatment agent is not particularly limited.

Before the pretreatment agent is applied to the inorganic substrate, the first reactive group of the polyfunctional monomer may be reacted with the organic functional group of the silane compound. Then, the pretreatment agent containing the silane compound to which the polyfunctional monomer is bonded may be applied to the inorganic substrate.

### (Inorganic Substrate)

The inorganic substrate is not particularly limited as long as it has a surface layer (inorganic surface) containing an inorganic compound. Examples of the inorganic compound include glass, metal, metal oxide, and silicon dioxide other than glass. Examples of the inorganic substrate include housing-related members such as sanitary crockery, tiles, enamels, glass, siding materials, sashes, walls, mirrors, and bathtubs. Among them, the pretreatment agent and the hydrophilizing treatment agent according to the present embodiment are particularly suitably used for sanitary crockery. Sanitary crockery is a residential equipment device to be installed at a water-using site in a building, such as a toilet bowl, a face washbasin, and a hand washbasin. Generally, crockery is obtained by glazing a surface of a base material (for example, unglazed ceramic) made of a starting material such as clay, pottery stone, or feldspar, followed by firing the base material. Most or a part of the sanitary crockery is made of ceramic, and a glassy layer is formed on the surface thereof.

### (2) Drying

It is preferable that after the pretreatment agent is applied, the inorganic substrate is dried to remove volatile components such as a solvent. This is because the polyfunctional monomer is easily disposed in the vicinity of a surface of the inorganic substrate. The drying conditions are not particularly limited, and are appropriately set according to the amount of the solvent, and the like.

### (3) Applying Hydrophilizing Treatment Agent

The hydrophilizing treatment agent is applied to the surface of the inorganic substrate. At this time, the polyfunctional monomer previously applied remains in the vicinity of the surface of the inorganic substrate. The hydrophilizing treatment agent is applied to cover the polyfunctional monomer. Thus, the polyfunctional monomer and the hydrophilizing treatment agent easily react with each other. The application amount of the hydrophilizing treatment agent is not particularly limited.

### (4) Fixing

After the application of the hydrophilizing treatment agent, the first reactive group of the polyfunctional monomer and the organic functional group of the silane compound, and the third reactive group of the hydrophilic compound and the second reactive group of the polyfunctional monomer are reacted. Through these reactions, the hydrophilic compound is fixed to the polyfunctional monomer, and the polyfunctional monomer is fixed to the silane compound.

The reaction conditions are appropriately set according to the reaction mechanism of each reactive group. The radical reaction can be carried out by heating and/or irradiation with an active energy ray. The condensation reaction can be carried out by heating.

The irradiation with the active energy ray is carried out using, for example, a high pressure mercury lamp, an ultra-high pressure mercury lamp, a metal halide lamp, or an ultraviolet LED lamp. The active energy ray is preferably an ultraviolet ray having a wavelength of 220 nm or more and 450 nm or less. The conditions of the irradiation with the active energy ray are not particularly limited, and are appropriately set according to the reactivity of each reactive group, the application amount of each component, and the like.

The heating is carried out by heating using a heating furnace, a hot air dryer, an IR heater, or the like, or heat irradiation using an infrared heat irradiation apparatus. The heating conditions are not particularly limited, and are appropriately set according to the reactivity of each reactive group, the application amount of each component, and the like. The heating temperature is, for example, 80° C. or higher and 150° C. or lower.

The inorganic substrate is then washed with water to remove unreacted components. Thereafter, the inorganic substrate is dried. By such a method, a hydrophilized inorganic substrate is obtained.

### EXAMPLES

The present invention will be described hereafter in more detail by way of examples, to which the present invention is not intended to be limited. In the examples, “parts” and “%” are on a mass basis unless otherwise indicated.

### Example 1

### (a) Preparation of Pretreatment Agent

First, 50 parts of 3-acryloxypropyltrimethoxysilane (silane compound), 50 parts of tripropylene glycol diacrylate (polyfunctional monomer), and an appropriate amount of 1-methoxy-2-propanol (solvent) were stirred and mixed at room temperature. Subsequently, 50 parts of a 3% aqueous hydrochloric acid solution (catalyst) was added, and the mixture was further stirred for 30 minutes. In this way, a pretreatment agent was prepared.

### (b) Preparation of Hydrophilizing Treatment Agent

First, hydrophilic compound Ha was synthesized as follows.

At a room temperature of 20 to 25° C., 45.2 parts of aminoethylsulfonic acid, 14.8 parts of sodium hydroxide, and 40 parts of ion-exchanged water were reacted. The obtained reaction product (42.5 parts) was kept at a temperature of 5 to 10° C., and a solution prepared by mixing and dissolving 24.5 parts of 2-isocyanatoethyl acrylate (KARENZ AOI (registered trademark) manufactured by Showa Denko K.K.) in 33 parts of 1-methoxy-2-propanol was added dropwise over 5 minutes, and the mixture was further stirred for 4 hours. In an infrared absorption spectrum, no absorption derived from an isocyanate group was observed, so that it was confirmed that the reaction completed. In this way, hydrophilic compound Ha (sodium sulfonate-containing urethane acrylate) was obtained.

Subsequently, 27.5 parts of ion-exchanged water and 10 parts of urea were mixed and stirred until the urea dissolved. Thereafter, 30 parts of the hydrophilic compound Ha obtained, 70 parts of (3-acrylamidopropyl)trimethylammonium chloride (hydrophilic compound Hc), 50 parts of 2-hydroxy-2-methyl-1-phenylpropan-1-one (photoradical polymerization initiator), and 100 parts of isopropyl alcohol (solvent) were added, and the solution was stirred until the solution became transparent. In this way, a hydrophilizing treatment agent was prepared.

### (c) Preparation of Inorganic Substrate

The surface of crockery was degreased with methanol to prepare an inorganic substrate.

### (d) Pretreatment

The pretreatment agent obtained was applied to an inorganic substrate. Subsequently, the resultant was dried at 60° C. for 30 minutes using an electric oven, and then left at room temperature for 30 minutes.

### (e) Hydrophilizing Treatment

Then, the hydrophilizing treatment agent was applied to the inorganic substrate to which the pretreatment agent had been applied. Subsequently, ultraviolet rays with an accumulated amount of light of 1000 mJ/cm² were applied using a high-pressure mercury lamp. Thus, a hydrophilized inorganic substrate was obtained.

### Examples 2 to 6, Comparative Examples 1 to 4

Pretreatment agents and hydrophilizing treatment agents were prepared and pretreatment and hydrophilizing treatment were carried out in the same method as in Example 1 except that the type, the amount, and the like of the polyfunctional monomer and the silane compound were changed as shown in Table 1.

### [Evaluation]

The hydrophilized inorganic substrates obtained in Examples and Comparative Examples were subjected to the following evaluations. The results of the evaluations are shown in Table 1.

### (i) Hydrophilicity

The contact angle (initial) of a water droplet on a surface of a hydrophilized inorganic substrate was measured in accordance with JIS R 3257 “Testing Method of Wettability of Glass Substrate” (Sessile Drop Method). Specifically, DMo-701 manufactured by Kyowa Interface Science Co., Ltd. was used for the measurement of the contact angle of a water droplet, and the contact angle was measured 60 seconds after 4 μL of distilled water was put dropwise to a coating film.

The contact angle was evaluated according to the following criteria.
◯: The contact angle of a water droplet is 20° or less.
Δ: The contact angle of a water droplet is larger than 20°.

### (ii) Durability (Cationic Detergent Resistance)

To a surface of a hydrophilized inorganic substrate was put dropwise 1 mL of a cleaning agent (SUNPOLE (registered trademark), cationic surfactant, manufactured by Dainihon Jochugiku Co., Ltd.), followed by washing with water. After this operation was repeated 10 times, the contact angle of a water droplet on the surface of the hydrophilized inorganic substrate was measured and evaluated in the same method as described above.

(iii) Antifouling Property (Mineral Removability)

150 μL of water was put dropwise to a hydrophilized inorganic substrate and dried at 40° C. for 24 hours, and thus, white water droplet spots were formed. Thereafter, in water at 20 to 25° C., 3M Scotch Bright (trademark) Antibacterial Urethane Sponge S-21KS was applied to the surface of the hydrophilized inorganic substrate, and reciprocated 20 times with application of a load of 500 gf.

The surface was visually observed and evaluated according to the following criteria.
⊙: No water droplet spots are visually recognized.
◯: Slight water droplet spots are visually recognized.
Δ: Water droplet spots are clearly visually recognized.

TABLE 1

| | | | Example | | | | | | Comparative Example | | | |
|---|---|---|---|---|---|---|---|---|---|---|---|---|
| | (Component) | (Name of compound) | 1 | 2 | 3 | 4 | 5 | 6 | 1 | 2 | 3 | 4 |
| Pre- | Silane | 3-Acryloxypropyltrimethoxysilane | 50 | 50 | 50 | 50 | 50 | 50 | 50 | 50 | | |
| treatment | compound | 3-Methacryloxypropyltrimethoxysilane | | | | | | | | | 50 | |
| agent | | 3-Acryloxypropyldimethoxysilane | | | | | | | | | | 50 |
| | Monofunctional | Isobornyl acrylate | | | | | | | | 50 | | |
| | monomer | | | | | | | | | | | |
| | Polyfunctional | Tripropylene glycol diacrylate | 50 | | | | | | | | | |
| | monomer | Isocyanuric acid EO-modified diacrylate | | 50 | | | | | | | | |
| | | Pentaerythritol tri- and tetraacrylate | | | 50 | | | | | | | |
| | | Ditrimethylolpropane tetraacrylate | | | | 50 | | | | | | |
| | | Dipentaerythritol penta- and hexaacrylate | | | | | 50 | | | | | |
| | | Acrylate of ε-caprolactone- | | | | | | 50 | | | | |
| | | modified dipentaerythritol | | | | | | | | | | |
| | Catalyst | 3% Hydrochloric acid | 50 | 50 | 50 | 50 | 50 | 50 | 50 | 50 | 50 | 50 |

| | | | | | | | | | | | |
|---|---|---|---|---|---|---|---|---|---|---|---|
| Eval- | (i) Hydrophilicity | ◯ | ◯ | ◯ | ◯ | ◯ | ◯ | ◯ | ◯ | ◯ | ◯ |
| uation | (ii) Durability (Cationic detergent resistance) | ◯ | ◯ | ◯ | ◯ | ◯ | ◯ | ◯ | ◯ | ◯ | ◯ |
| | (iii) Antifouling property (Mineral removability) | ◯ | ◯ | ◯ | ◯ | ⊙ | ⊙ | ◯ to Δ | Δ | Δ | Δ |

The hydrophilized inorganic substrates of Examples all exhibit good hydrophilicity, durability, and antifouling property. In contrast, all the hydrophilized inorganic substrates of Comparative Examples are poor in antifouling property.

### INDUSTRIAL APPLICABILITY

The surface treatment agent of the present disclosure can impart superior antifouling property as well as good and durable hydrophilicity to an inorganic substrate, and thus is suitably used especially as a hydrophilizing treatment agent for sanitary crockery.

This application claims priority based on Japanese Patent Application No. 2020-211303, which was filed in Japan on Dec. 21, 2020, the disclosure of which application is incorporated herein by reference in its entirety.

1. A surface treatment agent comprising a pretreatment agent and a hydrophilizing treatment agent and the pretreatment agent and the hydrophilizing treatment agent able to be sequentially applied to an inorganic substrate,
the pretreatment agent comprises:
a silane compound having a reactive silyl group and an organic functional group, and
a polyfunctional monomer,
the polyfunctional monomer has:
one or more first reactive groups that react with the organic functional group, and
one or more second reactive groups that react with the hydrophilizing treatment agent.

2. The surface treatment agent according to claim 1, wherein a blending amount of the polyfunctional monomer is 1% by mass or more and 99% by mass or less of a solid content of the pretreatment agent.

3. The surface treatment agent according to claim 1, wherein the first reactive group is at least one selected from the group consisting of an acrylamide group, an acryloyl group, a methacryloyl group, an allyl group, a vinyl group, a styryl group, and a mercapto group.

4. The surface treatment agent according to claim 1, wherein the second reactive group is at least one selected from the group consisting of an acrylamide group, an acryloyl group, a methacryloyl group, an allyl group, a vinyl group, a styryl group, and a mercapto group.

5. The surface treatment agent according to claim 1, wherein the hydrophilizing treatment agent comprises a hydrophilic compound, and
the hydrophilic compound has at least one of a sulfonic acid group and an alkali metal salt of a sulfonic acid group.

6. The surface treatment agent according to claim 1, wherein the hydrophilizing treatment agent comprises a hydrophilic compound, and
the hydrophilic compound has a quaternary ammonium group.

7. A hydrophilized inorganic substrate to which a pretreatment agent and a hydrophilizing treatment agent have been sequentially applied,
the pretreatment agent comprises a silane compound having a reactive silyl group and an organic functional group, and a polyfunctional monomer,
the polyfunctional monomer has one or more first reactive groups that react with the organic functional group and one or more second reactive groups that react with the hydrophilizing treatment agent, and
the hydrophilized inorganic substrate comprises:
an inorganic substrate,
the silane compound fixed to the inorganic substrate via the reactive silyl group,
the polyfunctional monomer fixed to the silane compound through a reaction between the organic functional group and the first reactive group, and
the hydrophilizing treatment agent fixed to the polyfunctional monomer through a reaction between the second reactive group and the hydrophilizing treatment agent.

8. A method for producing a hydrophilized inorganic substrate, the method comprising:
applying a pretreatment agent to a surface of an inorganic substrate;
applying a hydrophilizing treatment agent to a surface of the inorganic substrate to which the pretreatment agent has been applied; and
fixing the hydrophilizing treatment agent to the pretreatment agent,
the pretreatment agent comprises a silane compound having a reactive silyl group and an organic functional group, and a polyfunctional monomer,
the polyfunctional monomer has one or more first reactive groups that react with the organic functional group and one or more second reactive groups that react with the hydrophilizing treatment agent, and
in the fixing, the one or more first reactive groups and the organic functional group react with each other, and the hydrophilizing treatment agent and the one or more second reactive groups react with each other.
